(19) United States
(12) Patent Application Publication
(10) Pub. No.: US 2017/0278138 A1
(43) Pub. Date: Sep. 28, 2017

(54) ADVERTISING PLATFORM DEVICE AND METHOD OF OPERATING SAME

(71) Applicant: SK Planet Co., Ltd., Gyeonggi-do (KR)

(72) Inventor: Seung Kyoon YOON, Seoul (KR)

(73) Assignee: SK Planet Co., Ltd., Gyeonggi-do (KR)

(21) Appl. No.: 15/392,796

(22) Filed: Dec. 28, 2016

(30) Foreign Application Priority Data
Mar. 24, 2016 (KR) 10-2016-0035364

(51) Int. Cl. G06Q 30/02

(52) U.S. Cl. CPC G06Q 30/0268; G06Q 30/0238

(57) ABSTRACT

Disclosed are an advertising platform device and a method of operating the same for generating an analysis result for an advertisement by identifying in real time whether a particular coupon related to the advertisement has been actually used.

### CROSS-REFERENCE TO RELATED APPLICATIONS

The instant application is based on and claims priority to Korean Patent Application No. 10-2016-0035364, filed on Mar. 24, 2016. The disclosure of above-listed application is hereby incorporated by reference herein in their entirety.

### TECHNICAL FIELD

The present disclosure relates to a method of identifying in real time whether a coupon related to an advertisement has been actually used and using the coupon.

### BACKGROUND ART

As the market of applications which are advertisement media executed by mobile devices such as smart phones, tablet computers, and the like rapidly expands, the advertisement market related thereto is expanding at a high speed.

In connection with this, when executing the application or accessing a service page (for example, a webpage) which are the advertisement medium, the mobile device (hereinafter, referred to as a “terminal device”) receives an advertisement provided from an advertising platform device and displays the received advertisement.

At this time, the advertising platform device provides coupons related to the advertisement registered by an affiliate (for example, an advertiser) to a user, but there is a limitation in that whether the coupons have been used in reality (hereinafter, referred to as being actually used) for payment cannot be identified in real time.

That is, when the user uses the coupon for payment in an offline store (hereinafter, a store), payment information is transmitted only to an affiliate or a company (hereinafter, a store company) that manages the store, so that the advertising platform device that displays an actual coupon may identify whether the coupon has been used only after receiving the payment information from the store company or the affiliate.

However, since it is not easy to provide customer information on the payment information and it is difficult to make a real time linkage even though whether the coupon has been actually used is provided through the linkage with the affiliate or the store company, it takes a lot of time and costs in developing a system.

### SUMMARY

The present disclosure has been made to solve the above problem and an objective to be achieved in the present disclosure is to generate an analysis result for an advertisement by identifying in real time whether a particular coupon related to the advertisement has been actually used, thereby using the analysis result for marketing such as recommending another advertisement to be proposed in the future to an affiliate (for example, an advertiser) or for planning a new event.

An advertising platform device according to an embodiment of the present disclosure to achieve the objective includes: an identification unit configured to, when a particular coupon related to an advertisement is selected by a user of a terminal device, identify scan-related information measured at a payment time point of the particular coupon from the terminal device; a determination unit configured to determine whether the particular coupon has been actually used based on a result of the comparison between the scan-related information and an effective payment determination condition; and an analysis unit configured to, when the particular coupon has been actually used for payment, generate an analysis result for the advertisement based on use-related information identified according to the actual use of the particular coupon from the terminal device.

A method of operating an advertising platform device according to an embodiment of the present disclosure to achieve the objective includes: an identification step of, when a particular coupon related to an advertisement is selected by a user of a terminal device, identifying scan-related information measured at a payment time point of the particular coupon from the terminal device; a determination step of determining whether the particular coupon has been actually used based on a result of the comparison between the scan-related information and an effective payment determination condition; and an analysis step of, when the particular coupon has been actually used for payment, generating an analysis result for the advertisement based on use-related information identified according to the actual use of the particular coupon from the terminal device.

Accordingly, the advertising platform device and the method of operating the same according to the present disclosure can generate an analysis result for an advertisement by identifying in real time whether a particular coupon related to the advertisement has been actually used, thereby using the analysis result for marketing such as recommending another advertisement to be proposed in the future to an affiliate (for example, an advertiser) or for planning a new event.

### BRIEF DESCRIPTION OF THE DRAWINGS

The above and other objects, features and advantages of the present disclosure will be more apparent from the following detailed description taken in conjunction with the accompanying drawings, in which:

FIG. 1 schematically illustrates a configuration of an advertisement providing system according to an embodiment of the present disclosure;

FIG. 2 schematically illustrates a configuration of a terminal device according to an embodiment of the present disclosure;

FIG. 3 schematically illustrates a configuration of an advertising platform device according to an embodiment of the present disclosure;

FIG. 4 schematically illustrates a configuration of a hardware system for implementing the advertising platform device according to an embodiment of the present disclosure;

FIG. 5 is a flowchart illustrating a flow of operations in the terminal device according to an embodiment of the present disclosure; and

FIG. 6 is a flowchart illustrating a flow of operations in the advertising platform device according to an embodiment of the present disclosure.

### DETAILED DESCRIPTION OF THE EXEMPLARY EMBODIMENTS

It should be noted that the technical terms as used herein are merely used for describing particular embodiments, and are not intended to limit the scope of the present disclosure. Further, the technical terms in the specification should be construed as a meaning generally understood by those skilled in the art unless the terms are defined as another meaning and should not be construed as an excessively inclusive meaning or an excessively exclusive meaning. When a technical term used in the specification is an incorrect technical term which does not accurately express the idea of the present disclosure, the technical term should be replaced with the correct technical term which can be understood by those skilled in the art. Further, the general terms used in the present disclosure should be interpreted in the context according to the dictionary definition and should not be construed as possessing an excessively limited meaning.

In addition, a singular expression used in the specification includes a plural expression as long as they are clearly distinguished in the context. In the present disclosure, the term “comprise” or “include” should not be construed as necessarily including all of various elements or various steps disclosed herein, and it should be understood that some of the elements or steps may not be included, or additional elements or steps may be further included.

In addition, although terms including ordinal numbers such as first, second, and the like may be used to describe various elements, the elements should not be restricted by the terms. The terms are used merely for the purpose to distinguish an element from the other elements. For example, a first element may be termed a second element, and similarly, a second element may be termed a first element without departing from the scope of the present disclosure.

Hereinafter, embodiments of the present disclosure will be described in detail with reference to the accompanying drawings, equal or similar elements are assigned an equal reference numeral, and an overlapping description thereof will be omitted.

Further, in the following description of the technology of the present disclosure, a detailed description of known technologies incorporated herein will be omitted when it may make the subject matter of the present disclosure rather unclear. Further, it should be noted that the accompanying drawings are intended only for the easy understanding of the technical idea of the present disclosure, and the technical idea should not be construed as being limited by the accompanying drawings.

Hereinafter, an embodiment of the present disclosure will be described with reference to the accompanying drawings.

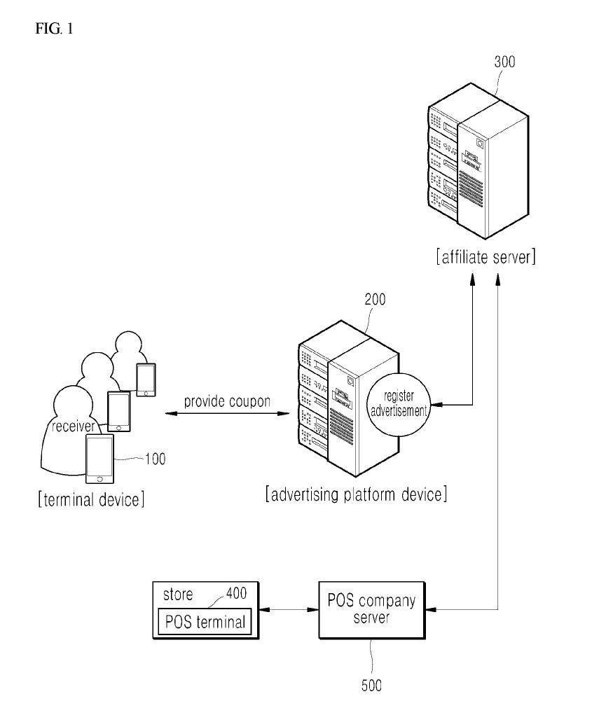

FIG. 1 illustrates an advertisement providing system according to an embodiment of the present disclosure.

As illustrated in FIG. 1, the advertisement providing system according to an embodiment of the present disclosure has a configuration that includes a terminal device 100 for receiving a coupon related to an advertisement, an advertising platform device 200 for providing the coupon to the terminal device 100, an affiliate server 300 for registering the advertisement in the advertising platform device 200, and a POS company server 500 for transmitting payment information to the affiliate server 300.

The terminal device 100 refers to a mobile device that receives an advertisement through an advertisement medium and performs a series of operations such as access to a service page related to an advertisement.

For example, the terminal device 100 may correspond to, for example, a smart phone, a tablet PC, and a PDA, but is not limited thereto and may include all devices which can receive an advertisement through an advertisement medium and execute a browser to access a service page (for example, a webpage).

The advertisement medium through which the terminal device 100 can receive an advertisement may correspond to, for example, an application executed by the terminal device 100 itself or a service page which the terminal device 100 may access after calling a browser.

The advertisement medium may be a solution application (for example, Syrup, OK cashback (OCB), or the like) for advertising an advertisement, and the terminal device 100 may perform a series of operations such as making a request for, receiving, and display the advertisement through the advertisement medium.

The advertising platform device 200 refers to an advertisement server for providing a coupon related to the advertisement registered by an advertiser to the terminal device 100.

When the advertisement is registered through the affiliate server 300, the advertising platform device 200 secures a receiver to receive the advertisement and provide a coupon to the terminal device 100 to generate an advertisement effect.

As described above, when the advertisement is registered from the affiliate server 300, the advertising platform device 200 may provide the coupon related to the advertisement to the terminal device 100, but has a limitation in that whether the coupon has been used in reality (hereinafter, referred to as being actually used) for payment cannot be identified in real time.

That is, when a user of the terminal device 100 uses the coupon for payment in an offline store (hereinafter, referred to as a store), the payment is performed by scanning a barcode of the coupon through a POS terminal 400 within the store while benefits such as discounts or a free offer are provided. A number list pool of a barcode defined in advance between the affiliate server 300 and the advertising platform device 200 or a barcode type including predetermined numbers fixed for discounts is included in the coupon. Accordingly, the payment using the coupon is performed in such a manner that the barcode of the coupon is recognized in the store and the discount is approved.

Payment information generated according to the actual use is provided only to the affiliate server 300 or a company that manages the offline store (hereinafter, referred to as a store company) (not shown) through the POS company server 500.

Accordingly, the advertising platform device 200 may identify whether the coupon has been actually used only after receiving the payment information from the affiliate server 300 or the store company.

However, since it is not easy to provide customer information on the payment information and it is difficult to make a real time linkage even though whether the coupon has been actually used is provided through the linkage with the affiliate server 300 or the store company, it takes a lot of time and costs in developing a system.

As a result, the advertising platform device 200 cannot identify whether the payment is actually performed using the coupon or the user simply searches for the coupon and thus cannot perform analysis according to the advertisement. Accordingly, it may be expected that the advertising platform device 200 can serve only as an agency of the advertisement.

Accordingly, an embodiment of the present disclosure proposes a method of identifying in real time whether the particular coupon related to the advertisement has been actually used to generate a result of an analysis for the advertisement and using the result for marketing such as recommending another advertisement to be proposed in the future to an affiliate (for example, an advertiser) or for planning a new event. Hereinafter, the advertising platform device 200 for implementing the method will be described in detail.

Meanwhile, prior to the detailed description of the advertising platform device 200, a configuration of the terminal device 100 is described to help in understanding the description.

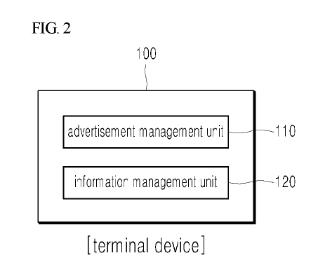

FIG. 2 illustrates a configuration of the terminal device 100 according to an embodiment of the present disclosure.

As illustrated in FIG. 2, the terminal device 100 according to an embodiment of the present disclosure may have a configuration that includes an advertisement management unit 110 and an information management unit 120.

All or at least some of the configuration of the terminal device 100 including the advertisement management unit 110 and the information management unit 120 may be implemented in the form of a software module or a hardware module executed by a processor or implemented in the form of a combination of the software module and the hardware module.

As a result, the terminal device 100 according to an embodiment of the present disclosure may receive an advertisement from the advertising platform device 200 through the above configuration and displays the received advertisement, and may provide scan-related information for identifying in real time whether a particular coupon has been actually used and use-related information for analyzing the advertisement. Hereinafter, each element within the terminal device 100 will be described in detail.

The advertisement management unit 110 performs a function of receiving the advertisement.

More specifically, the advertisement management unit 110 makes a request for the advertisement to the advertising platform device 200 according to execution of an application and, when the advertisement is received from the advertising platform device 200 according to the request for the advertisement, displays the received advertisement in an advertisement display area designated on an execution screen of the application.

For reference, the advertisement management unit 110 may issue terminal identification information by itself based on device identification information of the terminal device 100 (for example, MDN or IMEI) according to the execution of the application and make a request for the advertisement to the advertising platform device 200 based on the issued terminal identification information.

Further, the advertisement management unit 110 performs a function of monitoring the use of the coupon.

More specifically, when a particular coupon among the coupons related to the received advertisement in the advertisement display area is selected by the user, the selection of the particular coupon may be for payment or for search. Accordingly, in order to accurately monitor why the coupon is selected, the advertisement management unit 110 may generate a scan identification request signal and transfers the scan identification request signal to the information management unit 120.

The information management unit 120 performs a function of generating scan-related information at a payment time point when the coupon is scanned by a barcode scanner for the payment.

More specifically, if the scan identification request signal is received from the advertisement management unit 110, it means that a particular coupon has been selected by the user and displayed on the execution screen, so that the information management unit 120 makes a control to activate a photosensitive sensor and a proximity sensor.

That is, if the particular coupon is selected for the payment, the scan will be performed by the barcode scanner, so that the information management unit 120 activates the photosensitive sensor and the proximity sensor of the terminal device 100 and generates scan-related information.

The scan-related information corresponds to information measured at a payment time point when the particular coupon is scanned by the barcode scanner through the photosensitive sensor and the proximity sensor which are activated when the particular coupon is selected by the user, and includes at least one of an illumination measurement value, an illumination exposure time, and an approach distance measurement value.

At this time, the illumination measurement value corresponds to an illumination value generated by measuring a light radiated from the barcode scanner through the photosensitive sensor of the terminal device 100, the illumination exposure time corresponds to a time during which the illumination measurement value is maintained, and the approach distance measurement value corresponds to a distance between the particular coupon measured by the proximity sensor of the terminal device 100 and the barcode scanner.

As described above, the information management unit 120 generates the scan-related information by activating the photosensitive sensor and the proximity sensor of the terminal device 100 when the particular coupon is selected by the user, and transmits the scan-related information to the advertising platform device 200 to determine whether the particular coupon has been actually used.

When the scan-related information is not generated when the photosensitive sensor and the proximity sensor of the terminal device 100 are activated, it is preferably considered that the user has selected the particular coupon only for the purpose of search or the particular coupon has not been used for payment.

Meanwhile, the information management unit 120 performs a function of providing use-related information according to the actual use of the particular coupon.

More specifically, when an actual use confirmation signal for confirming the actual use of the particular coupon is received from the advertising platform device 200, the information management unit 120 collects use-related information and transfers the use-related information to the advertising platform device 200.

When the particular coupon has been actually used, the use-related information includes at least one piece of payment information generated according to an approval of the particular coupon and acquisition information which can be identified by the terminal device 100 at the payment time point. At this time, the acquisition information includes at least one of terminal identification information of the terminal device 100, a phone number, store location information, store wireless Internet information, payment time, and an actually used particular coupon.

That is, since the reception of the actual use confirmation signal for confirming the actual use of the particular coupon from the advertising platform device 200 means that effective payment is performed by the particular coupon, the information management unit 120 collects all pieces of acquisition information which can be identified by the terminal device 100 at the payment time point while collecting payment information generated according to the approval of the particular coupon.

As a result, the information management unit 120 transmits the use-related information including the payment information and the acquisition information to the advertising platform device 200 to make the analysis for the advertisement through the particular coupon possible.

Accordingly, the advertising platform device 200 may determine whether the particular coupon has been actually used based on the scan-related information and generate a result of the analysis of the advertisement based on the use-related information collected when the actual use of the particular coupon is confirmed. A detailed description thereof will be made with reference to the description of the advertising platform device 200.

Meanwhile, an embodiment of the present disclosure has described that, when the terminal device 100 measures scan-related information at a payment time point of the particular coupon and transmits the scan-related information to the advertising platform device 200, the advertising platform device 200 determines whether the particular coupon has been actually used based on the scan-related information, generates an actual use confirmation signal, and then transmits the actual use confirmation signal to the terminal device 100, and the terminal device 100 having received the actual use confirmation signal from the advertising platform device 200 collects identified user-related information according to the actual use of the particular coupon and transmits the collected user-related information to the advertising platform device 200, but the present disclosure is not limited thereto. When both the process of determining whether the particular coupon has been actually used based on the scan-related information and the process of collecting the user-related information when the particular coupon has been actually used are performed by the terminal device 100 and then only a final relevant result is transmitted to the advertising platform device 200, the advertising platform device 200 may implement a function of analyzing the advertisement based on the final relevant result and providing a result of the analysis.

As described above, since the terminal device 100 determines whether the particular coupon has been actually used and, when the particular coupon has been actually used, collects user-related information and then transmits only a final relevant result to the advertising platform device 200, the advertising platform device 200 just analyzes the advertisement based on the final relevant result and provides a result of the analysis. Therefore, the terminal device 100 and the advertising platform device 200 may be free from load and the generation of errors through minimization of amounts of communication between the terminal device 100 and the advertising platform device 200, thereby drawing an effect of providing a rapid and highly accurate result of the analysis for the advertisement.

The description of the terminal device 100 according to an embodiment of the present disclosure is finished here, and a description of the advertising platform device 200 will continue.

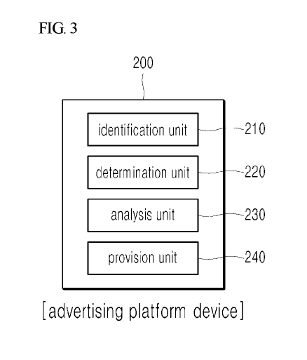

FIG. 3 illustrates a configuration of the advertising platform device 200 according to an embodiment of the present disclosure.

As illustrated in FIG. 3, the advertising platform device 200 according to an embodiment of the present disclosure may have a configuration that includes an identification unit 210 for identifying scan-related information measured at a payment time point of a particular coupon from the terminal device 100 when the particular coupon related to an advertisement is selected by the user of the terminal device 100, a determination unit 220 for determining whether the particular coupon has been actually used based on a result of a comparison between the scan-related information and an effective payment determination condition, an analysis unit 230 for generating a result of an analysis for the advertisement based on use-related information identified according to the actual use of the particular coupon from the terminal device 100 when the particular coupon has been actually used for payment, and a provision unit 240 for providing the result of the analysis for the advertisement.

All or at least some of the configuration of the advertising platform device 200 including the identification unit 210, the determination unit 220, the analysis unit 230, and the provision unit 240 may be implemented in the form of a hardware module or a software module executed by the processor or implemented in the form of a combination of the software module and the hardware module.

As a result, the advertising platform device 200 according to an embodiment of the present disclosure may identify in real time whether the particular coupon related to the advertisement has been actually used through the configuration and generates the result of the analysis for the advertisement. Then, the advertising platform device 200 may use the result of the analysis for marketing such as recommending another advertisement to be proposed in the future to the affiliate (for example, advertiser) or for planning a new event. Hereinafter, each element within the advertising platform device 200 for implementing the above will be described in detail.

The identification unit 210 performs a function of identifying scan-related information measured at a payment time point of the particular coupon.

More specifically, when the particular coupon is selected by the user from the coupons related to the received advertisement in the advertisement display area according to execution of the application of the terminal device 100, the identification unit 210 identifies scan-related information measured at a payment time point of the particular coupon.

The scan-related information corresponds to information measured at a payment time point when the particular coupon is scanned by the barcode scanner through the photosensitive sensor and the proximity sensor of the terminal device 100 which are activated when the particular coupon is selected by the user, and includes at least one of an illumination measurement value, an illumination exposure time, and an approach distance measurement value.

At this time, the illumination measurement value corresponds to an illumination value generated by measuring a light radiated from the barcode scanner through the photosensitive sensor of the terminal device 100, the illumination exposure time corresponds to a time during which the illumination measurement value is maintained, and the approach distance measurement value corresponds to a distance between the particular coupon measured by the proximity sensor of the terminal device 100 and the barcode scanner.

That is, when the particular coupon is selected for payment, the scan is performed by the barcode scanner. Then, the photosensitive sensor of the terminal device 100 may generate the illumination measurement value and count the time during which the illumination measurement value is exposed. Further, the proximity sensor of the terminal device 100 may generate an approach distance measurement value according to a distance between the particular coupon and the barcode scanner.

Accordingly, the identification unit 210 may receive scan-related information measured at the payment time point of the particular coupon from the terminal device 100 and identify the received scan-related information.

The determination unit 220 performs a function of determining whether the particular coupon has been actually used based on the scan-related information.

More specifically, the determination unit 220 determines whether the particular coupon has been actually used based on a result of a comparison between the scan-related information and an effective payment determination condition.

The effective payment determination condition includes at least one of an illumination threshold range, an exposure time threshold range, and a distance threshold range which are references for determining whether the particular coupon has been actually used.

First, the determination unit 220 performs a first condition determination by comparing the illumination measurement value of the scan-related information and the illumination threshold range of the effective payment determination condition.

That is, when the illumination measurement value is included in the illumination threshold range based on the comparison between the illumination threshold range corresponding to the illumination of the barcode scanner and the illumination measurement value, the determination unit 220 determines that the particular coupon effectively approaches the barcode scanner that radiates high illumination rather than general indoor lighting.

At this time, the illumination threshold range may be a value between a minimum illumination value and a maximum illumination value which can be measured when the barcode scanner effectively approaches the particular coupon, and may be an experimental value measured by an experiment.

Thereafter, when it is determined that the illumination measurement value is effective according to the first condition determination, the determination unit 220 generates a first condition determination result including the illumination measurement value.

Further, the determination unit 220 performs a second condition determination by comparing the exposure time of the scan-related information and the exposure time threshold range of the effective payment determination condition.

That is, when the time during which the effective illumination measurement value is exposed is counted and the time is included in the exposure time threshold range, the determination unit 220 determines that the barcode scanner effectively approaches the coupon to operate for payment for a predetermined time.

At this time, the exposure time threshold range may be a time (for example, 1 to 3 seconds) required generally when the barcode scanner recognizes a barcode of the coupon and may be an experimental value measured by an experiment.

Thereafter, when it is determined that the time during which the illumination measurement value included in the illumination threshold range is exposed is effective according to a second condition determination, the determination unit 220 generates a second condition determination result including the corresponding exposure time.

Further, the determination unit 220 performs a third condition determination by comparing the approach distance measurement value of the scan-related information and the distance threshold range of the effective payment determination condition.

That is, when the approach distance measurement value measured when the barcode scanner approaches the coupon for payment is included in the distance threshold range suitable for scanning for the particular coupon, the determination unit 220 determines that the barcode scanner approaches the particular coupon within the effective distance to make the payment possible.

At this time, the distance threshold range may be a value between a minimum distance and a maximum distance required when the barcode scanner recognizes the barcode of the coupon and may be an experimental value measured by an experiment.

Thereafter, when it is determined that the approach distance measurement value is effective according to a third condition determination, the determination unit 220 generates a third condition determination result including the approach distance measurement value.

As described above, when the performance of the first condition determination to the third condition determination has been completed and the first condition determination result to the third condition determination result are generated, the determination unit 220 determines whether the particular coupon has been actually used by combining at least one of the first condition determination result to the third condition determination result.

For example, when it is determined whether the particular coupon has been actually used based on the first condition determination result to the third condition determination result, the determination unit 220 synthetically determines whether the effective illumination measurement value is maintained for a minimum time (for example, 1 second) required for recognizing the barcode and such a payment operation is performed within a distance required for recognizing the barcode and thus, only when the effective payment is performed, determines that the particular coupon has been actually used.

Although it has been described that whether the particular coupon has been actually used is determined based on the first condition determination to the third condition determination in an embodiment of the present disclosure, the present disclosure is not limited thereto, and whether the particular coupon has been actually used may be determined by determining whether the effective payment is performed based on a combination of various conditions (for example, whether the proximity sensor and an exposure time match) as well as the aforementioned illumination threshold range, the exposure time threshold range, and the distance threshold range.

When the particular coupon has been actually used for payment, the analysis unit 230 performs a function of generating the result of the analysis for the advertisement.

More specifically, when the particular coupon has been actually used for payment, the analysis unit 230 receives use-related information identified according to the actual use of the particular coupon from the terminal device 100.

When the particular coupon has been actually used, the use-related information includes at least one piece of payment information generated according to an approval of the particular coupon and acquisition information which can be identified by the terminal device 100 at the payment time point. At this time, the acquisition information includes at least one of terminal identification information of the terminal device 100, a phone number, store location information, store wireless Internet information, payment time, and an actually used particular coupon.

Thereafter, the analysis unit 230 generates the result of the analysis for the advertisement based on the use-related information.

That is, the analysis unit 230 may generate the result of the analysis for the advertisement based on at least piece of the payment information and the acquisition information of the use-related information and recommend another advertisement to be proposed in the future based on the result of the analysis for the advertisement.

For example, when a number of pieces of payment information of the particular coupon collected by a plurality of users is larger than or equal to a threshold value among coupons related to a plurality of events and the number of pieces of payment information of the particular coupon collected in store A is larger among a plurality of stores in which the particular coupon can be used, the analysis unit 230 generates a result of an analysis for the advertisement based on the analysis that consumers are more interested in an event related to the particular coupon even in spite of uniformly provided events and store A is preferred for use of the particular coupon.

Further, the analysis unit 230 may figure out the reason why the users prefer store A by analyzing acquisition information such as store location information related to store A which a plurality of users prefer and store wireless Internet information, and plan and propose a new event to improve preferences of other stores based on the analysis.

In addition, the analysis unit 230 may analyze a geographical distribution and movement of the users by analyzing acquisition information such as terminal identification information of the terminal device 100, a payment time, and a type of the actually used particular coupon, and recommend another advertisement to be proposed in the future based on the analysis.

The provision unit 240 performs a function of providing the result of the analysis for the advertisement.

More specifically, when the generation of the result of the analysis for the advertisement is completed based on the use-related information, the provision unit 240 provides the result of the analysis for the advertisement to the affiliate server 300.

That is, when the particular coupon is selected by the user of the terminal device, the provision unit 240 may transfer the result of the analysis for the advertisement generated based on the result of the determination for whether the particular coupon has been actually used to the affiliate server 300 and thus recommend another advertisement to be proposed in the future to the affiliate (for example, advertiser) or plan and propose a new event.

Although it has been described that the terminal device 100 transmits the use-related information when the advertising platform device 200 determines whether the particular coupon has been actually used based on the scan-related information provided from the terminal device 100 and then provides the result of the determination to the terminal device 100, the present disclosure is not limited thereto, and the use-related information may be transmitted to the advertising platform device 200 only when the terminal device 100 collects the scan-related information and it is determined that the coupon has been actually used through all processes for determining whether the coupon has been actually used.

It has been mentioned that each element within the advertising platform device 200 may be implemented in the form of the hardware module or the software module executed by the processor or implemented in the form of the combination of the software module or hardware module.

As described above, the hardware module or the software module executed by the processor, and the combination of the software module and the hardware module may be implemented by a hardware system (for example, a computer system).

In connection with this, hereinafter, a hardware system 2000 for implementing the advertising platform device 200 according to an embodiment of the present disclosure will be described.

For reference, the following description is only an example for implementing each element within the advertising platform device 200 in the hardware system 2000 and each element and an operation thereof may be different from those in an actual system.

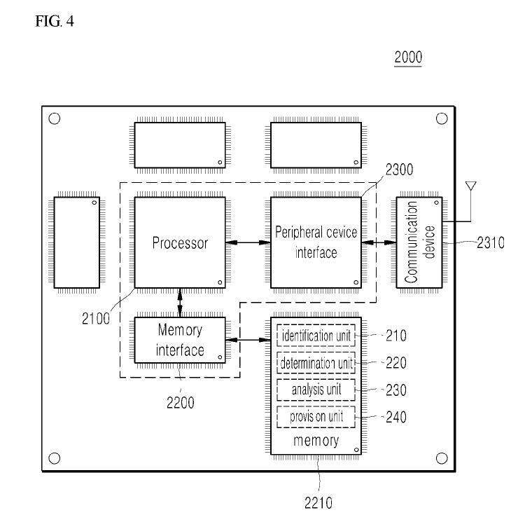

FIG. 4 illustrates a structure of the hardware system for implementing the advertising platform device 200 according to an embodiment of the present disclosure.

As illustrated in FIG. 4, the hardware system 2000 for implementing the advertising platform device 200 according to an embodiment of the present disclosure may have a configuration that includes a processor 2100, a memory interface 2200, and a peripheral device interface 2300.

Each element within the hardware system 2000 may be an individual component or may be integrated into an integrated circuit, and such elements may be combined with a bus system (not shown).

The bus system corresponds to one or more individual physical buses, communication lines/interfaces, and/or multi-drop connected by proper bridges, adaptors, and/or controllers, or abstraction indicating or point-to-point connections.

The processor 2100 serves to execute various software modules stored in a memory 2210 by communicating with the memory 2210 through a memory interface 2200 to perform various functions in the hardware system.

The identification unit 210, the determination unit 220, the analysis unit 230, and the provision unit 240 which are the elements within the advertising platform device 200 described with reference to FIG. 4 may be stored in the memory 2210 in the form of a software module implemented by instructions, and an operating system may be additionally stored in the memory 2210.

The operating system (for example, an embedded operating system such as I-OS, Android, Darwin, RTXC, LINUX, UNIX, OS X, WINDOWS, or VxWorks) includes various procedures for controlling and managing general system tasks (for example, memory management, storage device control, and power management), an instruction set, a software component, and/or a driver, and serves to make communication between various hardware modules and software modules easy.

For reference, the memory 2210 includes a cache, a main memory, and a secondary memory but is not limited thereto, and may include a memory layer structure. The memory layer structure may be implemented through a predetermined combination of, for example, a RAM (for example, SRAM, DRAM, or DDRAM), a ROM, a FLASH, a magnetic and/or optical storage device (for example, a disk drive, a magnetic tape, a Compact Disk (CD), and a Digital Video Disc (DVD)).

The peripheral device interface 2300 serves to enable communication between the processor 2100 and peripheral devices.

The peripheral devices provide different functions to the computer system, and may include, for example, a communication device 2310 in an embodiment of the present disclosure.

The communication device 2310 serves to provide a communication function with another device. To this end, the communication device 2310 includes, for example, an antenna system, an RF transceiver, on or more amplifiers, a tuner, one or more oscillators, a digital signal processor, a CODEC chipset, and a memory, but is not limited thereto, and may include a known circuit for performing the function.

A communication protocol supported by the communication device 2310 may correspond to a protocol for, for example, Long Term Evolution (LTE), Time division Multiple Access (TDMA), Code Division Multiple Access (CDMA), Global System for Mobile communications (GSM), Enhanced Data GSM Environment (EDGE), Wideband Code Division Multiple Access (W-CDMA), Wi-Fi (IEEE 802.11a, IEEE 802.11b, IEEE 802.11g, and/or IEEE 802.11n), Bluetooth, Wi-MAX, Voice over Internet Protocol (VoIP), email, instant messaging, and Short Message Service (SMS) but is not limited thereto, and may include all protocols that provide a communication environment with another device.

As a result, when executed by the processor 2100, each element within the advertising platform device 200 stored in the memory 2210 in the form of the software module may identify in real time whether the particular coupon related to the advertisement has been actually used by communicating with the communication device 2310 and the input/output device 2320 by a medium of the memory interface 2100 and the peripheral device interface 2300, generate the result of the analysis for the advertisement, and use the result for marketing such as recommending another advertisement to be proposed in the future to the affiliate (for example, advertiser) or for planning a new event.

Hereinafter, each element within the hardware system 2000 for implementing the advertising platform device 200 will be described in detail with reference to FIG. 4.

For convenience of the description, it is assumed that each element within the advertising platform device 200 stored in the memory 2210 in the form of the software module has been executed by the processor 2100.

The identification unit 210 performs a function of identifying scan-related information measured at a payment time point of the particular coupon.

More specifically, when the particular coupon is selected by the user from the coupons related to the received advertisement in the advertisement display area according to execution of the application of the terminal device 100, the identification unit 210 identifies scan-related information measured at a payment time point of the particular coupon.

The scan-related information corresponds to information measured at a payment time point when the particular coupon is scanned by the barcode scanner through the photosensitive sensor and the proximity sensor of the terminal device 100 which are activated when the particular coupon is selected by the user, and includes at least one of an illumination measurement value, an illumination exposure time, and an approach distance measurement value.

At this time, the illumination measurement value may correspond to an illumination value generated by measuring a light radiated from the barcode scanner through the photosensitive sensor of the terminal device 100, the illumination exposure time may correspond to a time during which the illumination measurement value is maintained, and the approach distance measurement value may correspond to a distance between the particular coupon measured by the proximity sensor of the terminal device 100 and the barcode scanner.

That is, the identification unit 210 may receive the scan-related information measured at the payment time point of the particular coupon from the terminal device 100 through the communication device 2310 and identify the received scan-related information.

The determination unit 220 performs a function of determining whether the particular coupon has been actually used based on the scan-related information.

More specifically, the determination unit 220 determines whether the particular coupon has been actually used based on a result of a comparison between the scan-related information and an effective payment determination condition.

The effective payment determination condition includes at least one of an illumination threshold range which is a reference for determining whether the particular coupon has been actually used, an exposure time threshold range, and a distance threshold range.

First, the determination unit 220 performs a first condition determination by comparing the illumination measurement value of the scan-related information and the illumination threshold range.

That is, when the illumination measurement value is included in the illumination threshold range based on the comparison between the illumination threshold range corresponding to the illumination of the barcode scanner and the illumination measurement value, the determination unit 220 determines that the particular coupon effectively approaches the barcode scanner that radiates high illumination and is not general indoor lighting.

At this time, the illumination threshold range may be a value between a minimum illumination value and a maximum illumination value which can be measured when the barcode scanner effectively approaches the particular coupon, and may be an experimental value measured by an experiment.

Thereafter, when it is determined that the illumination measurement value is effective according to the first condition determination, the determination unit 220 generates a first condition determination result including the illumination measurement value.

Further, the determination unit 220 performs a second condition determination by comparing the exposure time of the scan-related information and the exposure time threshold range of the effective payment determination condition.

That is, when the time during which the effective illumination measurement value is exposed is counted and the time is included in the exposure time threshold range, the determination unit 220 determines that the barcode scanner effectively approaches the coupon to operate for payment for a predetermined time.

At this time, the exposure time threshold value may be a time (for example, 1 to 3 seconds) required generally when the barcode scanner recognizes a barcode of the coupon and may be an experimental value measured by an experiment.

Thereafter, when it is determined that the time during which the illumination measurement value included in the illumination threshold range is exposed is effective according to a second condition determination, the determination unit 220 generates a second condition determination result including the corresponding exposure time.

Further, the determination unit 220 performs a third condition determination by comparing the approach distance measurement value of the scan-related information and the distance threshold range of the effective payment determination condition.

That is, when the approach distance measurement value measured when the barcode scanner approaches the coupon for payment is included in the distance threshold range suitable for scanning for the particular coupon, the determination unit 220 determines that the barcode scanner approaches the particular coupon within the effective distance to make the payment possible.

At this time, the distance threshold range may be a value between a minimum distance and a maximum distance required when the barcode scanner recognizes the barcode of the coupon and may be an experimental value measured by an experiment.

Thereafter, when it is determined that the approach distance measurement value is effective according to a third condition determination, the determination unit 220 generates a third condition determination result including the approach distance measurement value.

As described above, when the performance of the first condition determination to the third condition determination has been completed and the first condition determination result to the third condition determination result are generated, the determination unit 220 determines whether the particular coupon has been actually used by combining at least one of the first condition determination result to the third condition determination result.

For example, when it is determined whether the particular coupon has been actually used based on the first condition determination result to the third condition determination result, the determination unit 220 synthetically determines whether the effective illumination measurement value is maintained for a minimum time (for example, 1 second) required for recognizing the barcode and such a payment operation is performed within a distance required for recognizing the barcode and thus, only when the effective payment is performed, determines that the particular coupon has been actually used.

When the particular coupon has been actually used for payment, the analysis unit 230 performs a function of generating the result of the analysis for the advertisement.

More specifically, when the particular coupon has been actually used for payment, the analysis unit 230 receives the use-related information identified according to the actual use of the particular coupon from the terminal device 100 through the communication device 2310.

When the particular coupon has been actually used, the use-related information includes at least one piece of payment information generated according to an approval of the particular coupon and acquisition information which can be identified by the terminal device 100 at the payment time point. At this time, the acquisition information includes at least one of terminal identification information of the terminal device 100, a phone number, store location information, store wireless Internet information, payment time, and an actually used particular coupon.

Thereafter, the analysis unit 230 generates the result of the analysis for the advertisement based on the use-related information.

That is, the analysis unit 230 may generate the result of the analysis for the advertisement based on at least piece of the payment information and the acquisition information of the use-related information and recommend another advertisement to be proposed in the future based on the result of the analysis for the advertisement.

For example, when a number of pieces of payment information of the particular coupon collected by a plurality of users is larger than or equal to a threshold value among coupons related to a plurality of events and the number of pieces of payment information of the particular coupon collected in store A is larger among a plurality of stores in which the particular coupon can be used, the analysis unit 230 generates a result of an analysis for the advertisement based on the analysis that consumers are more interested in an event related to the particular coupon even in spite of uniformly provided events and store A is preferred for use of the particular coupon.

Further, the analysis unit 230 may figure out the reason why the users prefer store A by analyzing acquisition information such as store location information related to store A which a plurality of users prefer and store wireless Internet information, and plan and propose a new event to improve preferences of other stores based thereon.

In addition, the analysis unit 230 may analyze a geographical distribution and movement of the user by analyzing acquisition information such as terminal identification information of the terminal device 100, a payment time, and a type of the actually used particular coupon, and recommend another advertisement to be proposed in the future based on the analysis.

The provision unit 240 performs a function of providing the result of the analysis for the advertisement.

More specifically, when the generation of the result of the analysis for the advertisement is completed based on the use-related information, the provision unit 240 provides the result of the analysis for the advertisement to the affiliate server 300 through the communication device 2310.

That is, when the particular coupon is selected by the user of the terminal device, the provision unit 240 may transfer the result of the analysis for the advertisement generated based on the result of the determination for whether the particular coupon has been actually used to the affiliate server 300 and thus recommend another advertisement to be proposed in the future to the affiliate (for example, advertiser) or plan and propose a new event.

As described above, the advertising platform device 200 according to an embodiment of the present disclosure may identify in real time whether the particular coupon related to the advertisement has been actually used and generate the result of the analysis for the advertisement, thereby achieving an effect of using the result for marketing such as recommending another advertisement to be proposed in the further to the affiliate (for example, advertiser) or for planning a new event.

The description of the configuration of the advertising platform device 200 according to an embodiment of the present disclosure is finished here, and a description of a flow of operations in the terminal device 100 will continue.

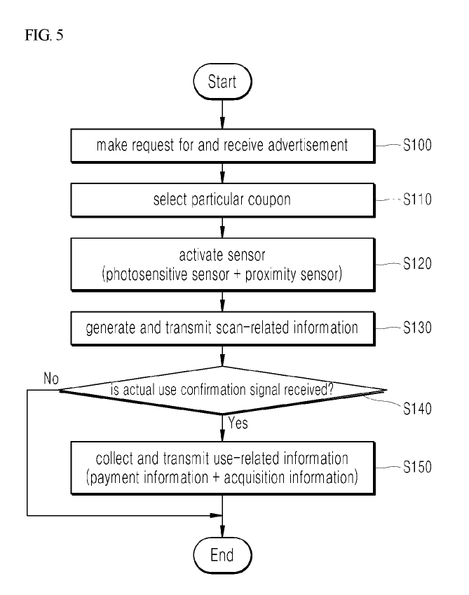

FIG. 5 is a flowchart illustrating the flow of the operations in the terminal device 100 according to an embodiment of the present disclosure, and the flow of the operations in the terminal device 100 with reference to the flowchart will be described below. In FIG. 5, the user of the terminal device 100 downloads a particular coupon related to an advertisement and uses the coupon in a store.

First, when the user of the terminal device 100 receives the particular coupon related to the advertisement from the advertising platform device 200, the user selects a product to be purchased in the store in which the particular coupon can be used and moves to a counter.

Thereafter, the user of the terminal device 100 selects the particular coupon received in an advertisement display area by executing an application.

That is, the advertisement management unit 110 makes a request for the advertisement to the advertising platform device 200 according to execution of the application and stores the particular coupon related to the advertisement from the advertising platform device 200 according to the request for the advertisement. When the user selects the particular coupon for payment, the advertisement management 110 displays the particular coupon in the advertisement display area in S100.

At this time, when the particular coupon is selected by the user among the coupons related to the received advertisement in the advertisement display area, the selection of the particular coupon may be for payment or for search. Accordingly, in order to accurately monitor why the coupon is selected, the advertisement management unit 110 may generate a scan identification request signal and transfers the scan identification request signal to the information management unit 120 in S110.

If the scan identification request signal is received from the advertisement management unit 110, it means that the particular coupon is selected by the user and displayed on an execution screen, so that the information management unit 120 makes a control to activate the photosensitive sensor and the proximity sensor of the terminal device 100 in S120.

That is, if the particular coupon is selected for the payment, the scan will be performed by the barcode scanner, so that the information management unit 120 activates the photosensitive sensor and the proximity sensor of the terminal device 100 and generates scan-related information.

The scan-related information corresponds to information measured at a payment time point when the particular coupon is scanned by the barcode scanner through the photosensitive sensor and the proximity sensor which are activated when the particular coupon is selected by the user, and includes at least one of an illumination measurement value, an illumination exposure time, and an approach distance measurement value.

At this time, the illumination measurement value may correspond to an illumination value generated by measuring a light radiated from the barcode scanner through the photosensitive sensor of the terminal device 100, the illumination exposure time may correspond to a time during which the illumination measurement value is maintained, and the approach distance measurement value may correspond to a distance between the particular coupon measured by the proximity sensor of the terminal device 100 and the barcode scanner.

That is, if the particular coupon is selected for the payment, the scan will be performed by the barcode scanner, so that the information management unit 120 generates scan-related information based on the information sensed by the activated photosensitive sensor and proximity sensor of the terminal device 100.

As described above, the information management unit 120 generates the scan-related information by activating the photosensitive sensor and the proximity sensor of the terminal device 100 when the particular coupon is selected by the user, and transmits the scan-related information to the advertising platform device 200 to determine whether the particular coupon has been actually used in S130.

When the scan-related information is not generated when the photosensitive sensor and the proximity sensor of the terminal device 100 are activated, it is preferably considered that the user has selected the particular coupon only for the purpose of search or the particular coupon has not been used for payment.

When an actual use confirmation signal for confirming the actual use of the particular coupon is received from the advertising platform device 200, the information management unit 120 collects use-related information and transfers the use-related information to the advertising platform device 200 in S140 and S150.

When the particular coupon has been actually used, the use-related information includes at least one piece of payment information generated according to an approval of the particular coupon and acquisition information which can be identified by the terminal device 100 at the payment time point. At this time, the acquisition information includes at least one of terminal identification information of the terminal device 100, a phone number, store location information, store wireless Internet information, payment time, and an actually used particular coupon.

That is, since the reception of the actual use confirmation signal for confirming the actual use of the particular coupon from the advertising platform device 200 means that effective payment is performed by the particular coupon, the information management unit 120 collects all pieces of acquisition information which can be identified by the terminal device 100 at the payment time point while collecting payment information generated according to the approval of the particular coupon.

The description for the flow of the operations in the terminal device 100 according to an embodiment of the present disclosure is finished here, and a flow of operations in the advertising platform device 200 will continue.

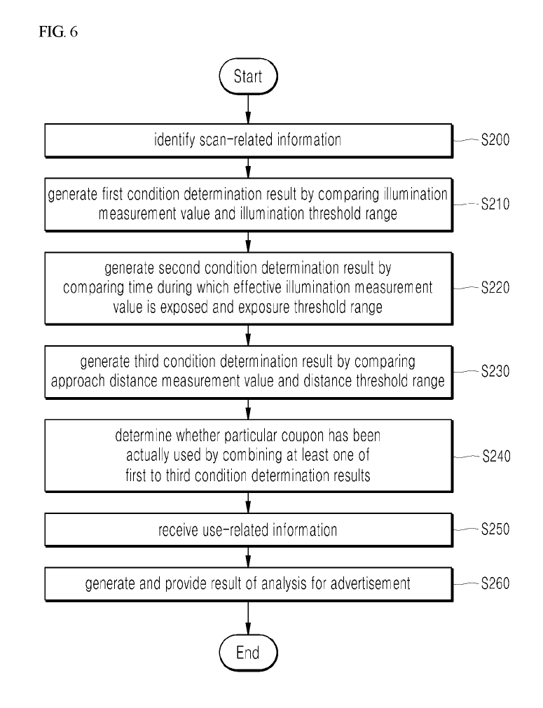

FIG. 6 is a flowchart illustrating the flow of the operations in the advertising platform device 200 according to an embodiment of the present disclosure, and the flow of the operations in the advertising platform device 200 with reference to the flowchart will be described below.

First, when the particular coupon is selected by the user from coupons related to the received advertisement in the advertisement display area according to execution of the application of the terminal device 100, the identification unit 210 identifies scan-related information measured at a payment time point of the particular coupon in S200.

The scan-related information corresponds to information measured at a payment time point when the particular coupon is scanned by the barcode scanner through the photosensitive sensor and the proximity sensor which are activated when the particular coupon is selected by the user, and includes at least one of an illumination measurement value, an illumination exposure time, and an approach distance measurement value.

At this time, the illumination measurement value corresponds to an illumination value generated by measuring a light radiated from the barcode scanner through the photosensitive sensor of the terminal device 100, the illumination exposure time corresponds to a time during which the illumination measurement value is maintained, and the approach distance measurement value corresponds to a distance between the particular coupon measured by the proximity sensor of the terminal device 100 and the barcode scanner.

That is, when the particular coupon is selected for payment, the scan is performed by the barcode scanner. Then, the photosensitive sensor of the terminal device 100 may generate the illumination measurement value and count the time during which the illumination measurement value is exposed. Further, the proximity sensor of the terminal device 100 may generate an approach distance measurement value according to a distance between the particular coupon and the barcode scanner.

Accordingly, the identification unit 210 may receive scan-related information measured at the payment time point of the particular coupon from the terminal device 100 and identify the received scan-related information.

The determination unit 220 determines whether the particular coupon has been actually used based on a result of the comparison between the scan-related information and an effective payment determination condition.

The effective payment determination condition includes at least one of an illumination threshold range which is a reference for determining whether the particular coupon has been actually used, an exposure time threshold range, and a distance threshold range.

First, the determination unit 220 performs a first condition determination by comparing the illumination measurement value of the scan-related information and the illumination threshold range.

That is, when the illumination measurement value is included in the illumination threshold range based on the comparison between the illumination threshold range corresponding to the illumination of the barcode scanner and the illumination measurement value, the determination unit 220 determines that the particular coupon effectively approaches the barcode scanner that radiates high illumination rather than general indoor lighting.

At this time, the illumination threshold range may be a value between a minimum illumination value and a maximum illumination value which can be measured when the barcode scanner effectively approaches the particular coupon, and may be an experimental value measured by an experiment.

Thereafter, when it is determined that the illumination measurement value is effective according to the first condition determination, the determination unit 220 generates a first condition determination result including the illumination measurement value in S210.

Further, the determination unit 220 performs a second condition determination by comparing the exposure time of the scan-related information and the exposure time threshold range of the effective payment determination condition.

That is, when the time during which the effective illumination measurement value is exposed is counted and the time is included in the exposure time threshold range, the determination unit 220 determines that the barcode scanner effectively approaches the coupon to operate for payment for a predetermined time.

At this time, the exposure time threshold range may be a time (for example, 1 to 3 seconds) required generally when the barcode scanner recognizes a barcode of the coupon and may be an experimental value measured by an experiment.

Thereafter, when it is determined that the time during which the illumination measurement value included in the illumination threshold range is exposed is effective according to a second condition determination, the determination unit 220 generates a second condition determination result including the corresponding exposure time in S220.

Further, the determination unit 220 performs a third condition determination by comparing the approach distance measurement value of the scan-related information and the distance threshold range of the effective payment determination condition.

That is, when the approach distance measurement value measured when the barcode scanner approaches the coupon for payment is included in the distance threshold range suitable for scanning for the particular coupon, the determination unit 220 determines that the barcode scanner approaches the particular coupon within the effective distance to make the payment possible.

At this time, the distance threshold range may be a value between a minimum distance and a maximum distance required when the barcode scanner recognizes the barcode of the coupon and may be an experimental value measured by an experiment.

Thereafter, when it is determined that the approach distance measurement value is effective according to a third condition determination, the determination unit 220 generates a third condition determination result including the approach distance measurement value in S230.

As described above, when the performance of the first condition determination to the third condition determination is completed and the first condition determination result to the third condition determination result are generated, the determination unit 220 determines whether the particular coupon has been actually used by combining at least one of the first condition determination result to the third condition determination result.

For example, when it is determined whether the particular coupon has been actually used based on the first condition determination result to the third condition determination result, the determination unit 220 synthetically determines whether the effective illumination measurement value is maintained for a minimum time (for example, 1 second) required for recognizing the barcode and such a payment operation is performed within a distance required for recognizing the barcode and thus, only when the effective payment is performed, determines that the particular coupon has been actually used.

Although it has been described that whether the particular coupon has been actually used is determined based on the first condition determination to the third condition determination in an embodiment of the present disclosure, the present disclosure is not limited thereto, and whether the particular coupon has been actually used may be determined by determining whether the effective payment is performed based on a combination of various conditions (for example, whether the proximity sensor and an exposure time match) as well as the aforementioned illumination threshold range, the exposure time threshold range, and the distance threshold range.

When the particular coupon has been actually used for payment, the analysis unit 230 receives use-related information identified according to the actual use of the particular coupon from the terminal device 100 in S250.

When the particular coupon has been actually used, the use-related information includes at least one piece of payment information generated according to an approval of the particular coupon and acquisition information which can be identified by the terminal device 100 at the payment time point. At this time, the acquisition information includes at least one of terminal identification information of the terminal device 100, a phone number, store location information, store wireless Internet information, payment time, and an actually used particular coupon.

Thereafter, the analysis unit 230 may generate a result of an analysis for the advertisement based on at least one piece of payment information and acquisition information included in the use-related information and recommend another advertisement to be proposed in the future based on the result of the analysis for the advertisement in S260.

For example, when a number of pieces of payment information of the particular coupon collected by a plurality of users is larger than or equal to a threshold value among coupons related to a plurality of events and the number of pieces of payment information of the particular coupon collected in store A is larger among a plurality of stores in which the particular coupon can be used, the analysis unit 230 generates a result of an analysis for the advertisement based on the analysis that consumers are more interested in an event related to the particular coupon even in spite of uniformly provided events and store A is preferred for use of the particular coupon.

Further, the analysis unit 230 may figure out the reason why the users prefer store A by analyzing acquisition information such as store location information related to store A which a plurality of users prefer and store wireless Internet information, and plan and propose a new event to improve preferences of other stores based thereon.

In addition, the analysis unit 230 may analyze a geographical distribution and movement of the user by analyzing acquisition information such as terminal identification information of the terminal device 100, a payment time, and a type of the actually used particular coupon, and recommend another advertisement to be proposed in the future based on the analysis.

The provision unit 240 performs a function of providing the result of the analysis for the advertisement.

More specifically, when the generation of the result of the analysis for the advertisement is completed based on the use-related information, the provision unit 240 provides the result of the analysis for the advertisement to the affiliate server 300.

That is, when the particular coupon is selected by the user of the terminal device, the provision unit 240 may transfer the result of the analysis for the advertisement generated based on the result of the determination for whether the particular coupon has been actually used to the affiliate server 300 and thus recommend another advertisement to be proposed in the future to the affiliate (for example, advertiser) or plan and propose a new event.

As described above, based on the flow of the operations related to the advertising platform device 200 according to an embodiment of the present disclosure, it is possible to identify in real time whether the particular coupon related to the advertisement has been actually used and generate the result of the analysis for the advertisement, thereby achieving an effect of using the result for marketing such as recommending another advertisement to be proposed in the further to the affiliate (for example, advertiser) or for planning a new event.

Although it has been described that the terminal device 100 transmits the use-related information when the advertising platform device 200 determines whether the particular coupon has been actually used based on the scan-related information provided from the terminal device 100 and then provides the result of the determination to the terminal device 100, the present disclosure is not limited thereto, and the use-related information may be transmitted to the advertising platform device 200 only when the terminal device 100 collects the scan-related information and it is determined that the coupon has been actually used through all processes for determining whether the coupon has been actually used.

That is, it has been described that, when the terminal device 100 measures the scan-related information at the payment time point of the particular coupon and transmits the scan-related information to the advertising platform device 200, the advertising platform device 200 determines whether the particular coupon has been actually used based on the scan-related information, generates the actual use confirmation signal, and then transmits the actual use confirmation signal to the terminal device 100, and the terminal device 100 having received the actual use confirmation signal collects user-related information identified according to the actual use of the particular coupon and transmits the user-related information to the advertising platform device 200, but the present disclosure is not limited thereto. If the terminal device 100 performs both the process of determining whether the particular coupon has been actually used based on the scan-related information and the process of, when the particular coupon has been actually used, collecting the user-related information, and then transmits only a final relevant result to the advertising platform device 200, the advertising platform device 200 may analyze the advertisement based on the final relevant result and provides a result of the analysis.

As described above, the terminal device 100 determines whether the particular coupon has been actually used and, when the particular coupon has been actually used, collects the user-related information and then transmits only the final relevant result to the advertising platform device 200, so that the advertising platform device 200 just analyzes the advertisement based on the final relevant result and provide a result of the analysis. Therefore, the terminal device 100 and the advertising platform device 200 may be free from load and the generation of errors through minimization of amounts of communication between the terminal device 100 and the advertising platform device 200, thereby drawing an effect of providing a rapid and highly accurate result of the analysis for the advertisement.

The implementations of the functional operations and subject matter described in the present disclosure may be realized by a digital electronic circuit, by the structure described in the present disclosure and the equivalent including computer software, firmware, or hardware including, or by a combination of one or more thereof. Implementations of the subject matter described in the specification may be implemented in one or more computer program products, that is, one or more modules related to a computer program command encoded on a tangible program storage medium to control an operation of a processing system or the execution by the operation.

A computer-readable medium may be a machine-readable storage device, a machine-readable storage substrate, a memory device, a composition of materials influencing a machine-readable radio wave signal, or a combination of one or more thereof.

In the specification, the term “system” or “device”, for example, covers a programmable processor, a computer, or all kinds of mechanisms, devices, and machines for data processing, including a multiprocessor and a computer. The processing system may include, in addition to hardware, a code that creates an execution environment for a computer program when requested, such as a code that constitutes processor firmware, a protocol stack, a database management system, an operating system, or a combination of one or more thereof.

A computer program (also known as a program, software, software application, script, or code) can be written in any form of programming language, including compiled or interpreted languages, declarative or procedural languages, and it can be deployed in any form, including as a stand-alone program or module, a component, subroutine, or another unit suitable for use in a computer environment. A computer program may, but need not, correspond to a file in a file system. A program can be stored in a single file provided to the requested program, in multiple coordinated files (for example, files that store one or more modules, sub-programs, or portions of code), or in a portion of a file that holds other programs or data (for example, one or more scripts stored in a markup language document). A computer program can be deployed to be executed on one computer or on multiple computers that are located at one site or distributed across a plurality of sites and interconnected by a communication network.

A computer-readable medium suitable for storing a computer program command and data includes all types of non-volatile memories, media, and memory devices, for example, a semiconductor memory device such as an EPROM, an EEPROM, and a flash memory device, and a magnetic disk such as an external hard disk or an external disk, a magneto-optical disk, a CD-ROM, and a DVD-ROM disk. A processor and a memory may be added by a special purpose logic circuit or integrated into the logic circuit.

Implementations of the subject matter described in the specification may be implemented in a calculation system including a back-end component such as a data server, a middleware component such as an application server, a front-end component such as a client computer having a web browser or a graphic user interface which can interact with the implementations of the subject matter described in the specification by the user, or all combinations of one or more of the back-end, middleware, and front-end components. The components of the system can be mutually connected by any type of digital data communication such as a communication network or a medium.

While the specification contains many specific implementation details, these should not be construed as limitations on the scope of any disclosure or of what may be claimed, but rather as descriptions of features that may be specific to particular embodiments of particular disclosures. Certain features that are described in the specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

In addition, in the specification, the operations are illustrated in a specific sequence in the drawings, but it should not be understood that the operations are performed in the shown specific sequence or that all shown operations are performed in order to obtain a preferable result. In a specific case, a multitasking and parallel processing may be preferable. Furthermore, it should not be understood that a separation of the various system components of the above-mentioned implementation is required in all implementations. In addition, it should be understood that the described program components and systems usually may be integrated in a single software package or may be packaged in a multi-software product.

As described above, specific terms disclosed in the specification do not intend to limit the present disclosure. Therefore, while the present disclosure was described in detail with reference to the above-mentioned examples, a person skilled in the art may modify, change and transform some parts without departing a scope of the present disclosure. The scope of the present disclosure is defined by the appended claims to be described later, rather than the detailed description. Accordingly, it will be appreciated that all modifications or variations derived from the meaning and scope of the appended claims and their equivalents are included in the range of the present disclosure.

1. An advertising platform device comprising:
an identification unit configured to, when a particular coupon related to an advertisement is selected by a user of a terminal device, identify scan-related information measured at a payment time point of the particular coupon from the terminal device;
a determination unit configured to determine whether the particular coupon has been actually used based on a result of the comparison between the scan-related information and an effective payment determination condition; and
an analysis unit configured to, when the particular coupon has been actually used for payment, generate an analysis result for the advertisement based on use-related information identified according to the actual use of the particular coupon from the terminal device.

2. The advertising platform device of claim 1, wherein the scan-related information is measured at the payment time point when the particular coupon is scanned by a barcode scanner through a photosensitive sensor and a proximity sensor of the terminal device activated when the particular coupon is selected by the user, and includes at least one of an illumination measurement value, an illumination exposure time, and an approach distance measurement value.

3. The advertising platform device of claim 2, wherein the effective payment determination condition includes at least one of an illumination threshold range, an exposure time threshold range, and a distance threshold range that are references for determining whether the particular coupon has been actually used, and the determination unit determines whether the particular coupon has been actually used by combining at least one of a first condition determination for determining whether the illumination measurement value is included in the illumination threshold range corresponding to illumination of the barcode scanner, a second condition determination for determining whether the exposure time of the illumination measurement value included in the illumination threshold range is included in the exposure time threshold range, and a third condition determination for determining whether the approach distance measurement value is included in the distance threshold range suitable for scanning the particular coupon by the barcode scanner.

4. The advertising platform device of claim 1, wherein, when it is determined that the particular coupon has been actually used, the use-related information includes at least one piece of payment information generated according to the actual use of the particular coupon and acquisition information which can be identified by the terminal device at the payment time point, and the acquisition information includes at least one of terminal identification information of the terminal device, a phone number, store location information, store wireless Internet information, a payment time, and the actually used particular coupon.

5. The advertising platform device of claim 4, wherein the analysis unit generates an analysis result for the advertisement based on at least one piece of the payment information and the acquisition information, and recommends another advertisement to be proposed in the future or proposes a new event based on the analysis result for the advertisement.

6. A method of operating an advertising platform device, the method comprising:
an identification step of, when a particular coupon related to an advertisement is selected by a user of a terminal device, identifying scan-related information measured at a payment time point of the particular coupon from the terminal device;
a determination step of determining whether the particular coupon has been actually used based on a result of the comparison between the scan-related information and an effective payment determination condition; and
an analysis step of, when the particular coupon has been actually used for payment, generating an analysis result for the advertisement based on use-related information identified according to the actual use of the particular coupon from the terminal device.

7. The method of claim 6, wherein the scan-related information is measured at the payment time point when the particular coupon is scanned by a barcode scanner through a photosensitive sensor and a proximity sensor of the terminal device activated when the particular coupon is selected by the user, and includes at least one of an illumination measurement value, an illumination exposure time, and an approach distance measurement value.

8. The method of claim 7, wherein the effective payment determination condition includes at least one of an illumination threshold range, an exposure time threshold value, and a distance threshold range that are references for determining whether the particular coupon has been actually used, and the determination step determines whether the particular coupon has been actually used by combining at least one of a first condition determination for determining whether the illumination measurement value is included in the illumination threshold range corresponding to illumination of the barcode scanner, a second condition determination for determining whether the exposure time of the illumination measurement value included in the illumination threshold range is included in the exposure time threshold range, and a third condition determination for determining whether the approach distance measurement value is included in the distance threshold range suitable for scanning the particular coupon by the barcode scanner.

9. The method of claim 6, wherein, when it is determined that the particular coupon has been actually used, the use-related information includes at least one piece of payment information generated according to the actual use of the particular coupon and acquisition information which can be identified by the terminal device at the payment time point, and the acquisition information includes at least one of terminal identification information of the terminal device, a phone number, store location information, store wireless Internet information, a payment time, and the actually used particular coupon.

10. The method of claim 9, wherein the analysis step comprises:
generating an analysis result for the advertisement based on at least one piece of the payment information and the acquisition information;
recommending another advertisement to be proposed in the future or proposing new event based on the analysis result for the advertisement.
